(19) United States
(12) Patent Application Publication
(10) Pub. No.: US 2025/0330973 A1
(43) Pub. Date: Oct. 23, 2025

(54) METHOD FOR OPTIMIZING MULTIPLE TRAFFIC INFLUENCE REQUESTS IN A WIRELESS COMMUNICATION

(71) Applicants: Centre of Excellence in Wireless Technology, Chennai (IN); Tejas Networks, Bangalore (IN)

(72) Inventors: Nidhin Lingadurai, Chennai (IN); Vikram Krishnakumar, Chennai (IN); Anusuya Balasubramanian, Chennai (IN); Abhijeet Abhimanyu Masal, Chennai (IN); Jeniston Deviraj Klutto Milleth, Chennai (IN); Aswathy Subramaniam, Chennai (IN); Harini Shree Velmurugan, Chennai (IN)

(21) Appl. No.: 18/797,851

(22) Filed: Aug. 8, 2024

(30) Foreign Application Priority Data
Apr. 19, 2024 (IN) 202441031411

(51) Int. Cl. H04W 72/1263; H04L 67/51

(52) U.S. Cl. CPC H04W 72/1263; H04L 67/51

(57) ABSTRACT

The present disclosure provides new attributes in a request that includes mapping of the at least one traffic filter or at least one ethernet traffic filter with at least one traffic route in a map. In AF's create request the map includes a plurality of sets where each set includes a set identification number (SID), one of: the at least one traffic filter or the at least one ethernet traffic filter, and the at least one traffic route as the attributes. Further, each SID identifies each entry of at least one set in the map. In AF's update request, the map includes at least one set where each set includes a set identification number (SID) and optional attributes. The optional attributes comprise one or more of: at least one traffic filter and one of: at least one ethernet traffic filter or at least one traffic route. Further, each SID identifies each entry of at least one set in the map. This provides clarity for NEF to unambiguously interpret the external AF's create or update requests and translate the information towards the other 5G Core entities.

### CROSS REFERENCE TO RELATED APPLICATION

The present application claims priority to and the benefit of Indian Patent Application No. IN 202441031411, filed Apr. 19, 2024, the entire contents of which as are hereby incorporated herein by reference.

### BACKGROUND

### Related Field

The present disclosure, generally, relates to a method for managing traffic flow in a communication network. More particularly, the present disclosure relates to a method for optimizing multiple traffic influence requests in a wireless communication.

### Related Art

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

The 5G Core architecture has been designed to support a diverse array of services with unique requirements. The 5G architecture is characterized by a decentralized structure where each network function offers a different set of functionalities. Network Exposure is one of the functionalities introduced in 5G. The concept of network exposure is managed by a network function (NF) called Network Exposure Function (NEF) which offers numerous services like event monitoring, traffic influence, AFSession WithQoS, chargeable Party, etc. According to 3GPP TS 29.522, the Traffic Influence service offered by the NEF provides a facility for an external untrusted Application Function (uAF) to influence the user plane traffic of User Equipments (UE(s)).

FIG. 1 illustrates a general architecture of a 5G network. In general, the 5G network 100 includes the uAF 101 that interacts with the NEF 103 for exposing the core network to the uAF 101. The NEF 103 serves as a gateway and facilitates interactions with 5G Core network functions through standard Representational State Transfer (REST) Application Programming Interfaces (API)-based Hypertext Transfer Protocol (HTTP) interfaces. As depicted in FIG. 1, the 5G core network 113 may include various network functions like Access and Mobility Management Function (AMF) 105, Session Management Function (SMF) 107, Policy Control Function (PCF) 109, Unified Data Management (UDM)/Unified Data Repository (UDR) 111 along with NEF 103. The untrusted AF gains access to services offered by the 5G core. This allows multiple AFs, each with diverse service requirements, to interact with the 5G Core network 113 simultaneously.

The NEF 103 offers multiple service APIs which broadly come under either Northbound or Southbound APIs where external AFs can invoke the Northbound APIs while 5G Core NFs can invoke the Southbound APIs as shown in FIG. 1. On a high-level, the NEF services can be categorized into monitoring capability, provisioning capability, policy/charging capability, analytics capability, and network-status reporting capability.

Further, the 5G core network 113 provides a database that is managed by UDR/UDM 111. The UDR 111 in the 5G Core acts as the consolidated database for storing and retrieving subscriber, exposure, application, and policy data of the 5G network by the NF consumers. The UDR/UDM 111 acts as a front end for accessing the subscriber data of the UE(s). The PCF 109 is responsible for managing policies that regulate various aspects of the network. These policies encompass a wide range of functions, including quality of service (QOS), network resource allocation, authentication, mobility, security, and more.

FIG. 2A illustrates a general Traffic Influence Service API method. The Traffic Influence API offered by the NEF 103 comes under the category of policy/charging capability exposure. In general, the Traffic Influence Service API can be invoked by the uAF 101 for a variety of use cases such as traffic surveillance, police monitoring systems, etc. Using this API, a part of data heading towards one Data Network Access Identifier (DNAI) server of a Data Network (DN) can be directed to another DNAI server of the same DN, which allows the application to process the data at the required DNAI. An uAF can request for routing of single or multiple data flow(s) to a single or multiple DNAI(s).

For the traffic routing request, the uAF 101 invokes the Traffic Influence API, provided by the NEF 103 which has various attributes giving information on the specifics of the traffic influence request. The AF request includes key parameters among them are traffic filters and traffic routes defined as an array data type in the request payload of HTTP POST request and PATCH request. These two attributes provide two key information about the traffic to be influenced. First attribute, the traffic filters information, identifies the part of the data flow that needs to be routed. The traffic filters can either be IP filters or ethernet traffic filters. Another attribute, the traffic routes information, that defines the destination DNAI where the data flow needs to be routed.

FIG. 2B illustrates a Traffic Influence Service call flow 200 between AF, NEF, PCF and SMF. In general, the uAF 101 may invoke the traffic influence service API of NEF 103. In step 201, the AF 101 sends a Nnef_TrafficInfluence Create Request to the NEF 103. The Nnef_TrafficInfluence Create Request may be alternatively referred to as an AF request or traffic influence request. Further, the NEF 103 decides to transfer the request from the uAF 101 to the PCF 109 or to the UDR 111. Further, at step 203, if the AF request is for a single ongoing PDU session of a single UE with its corresponding UE IP address, then the request is transferred to the PCF 109 by NEF 103 using Npcf_PolicyAuthorization Create Request for further processing. Based on validation of the request and the policies allowed for dataflow, the PCF 109, at step 205, sends Npcf_PolicyAuthorization Create Response to the NEF 103 and thereafter, at step 207, the NEF 103 sends the Nnef_TrafficInfluence Create Response to the AF 101. Further at step 209, PCF 109 sends a Npcf_SMPolicyControl UpdateNotify request to SMF 107 for further processing and at step 211, SMF sends back Npcf_SMPolicyControl UpdateNotify response.

FIG. 3 illustrates a Traffic Influence service call flow 300 between AF, NEF, PCF, UDR and SMF. In general, the UDR's 111 consumers invoke the Data Repository API to store Application and Exposure Data, Subscriber Data and policy-related Data. In this, the NEF 103 invokes the Data Repository API of the UDR whenever there is the Traffic Influence request from the uAF for future utilization of the traffic influence feature. The request from the NEF can be for a group of UE(s) identified by the group ID, any UE, or an individual UE identified by a General Public Subscription Identifier (GPSI). This API stores the traffic influence request of uAF in the UDR. If the PCF had subscribed earlier or anytime later, for the modification to traffic influence data of application database, then UDR will notify PCF.

Referring back to FIG. 3, at step 301, if the AF request is for a single/multiple ongoing/future PDU session(s) of single or multiple UE(s) without UE IP address, then the request that is received from the uAF 101 is transferred to the UDR 111 by NEF 103 using Nudr_DataRepository create Request for further processing. Further, the UDR 111, at step 303, sends the Nudr_DataRepository Create Response upon receiving the request. The data in the request is then stored in the database of the UDR 111. Further, at step 305, if the PCF 109 had subscribed earlier or anytime later, regarding the updates to traffic influence data application database, then the UDR 111, notifies the PCF 109 using Nudr_DataRepository Notify Request. Accordingly, the PCF 109 sends the Nudr_DataRepository Notify Response to the UDR 111 at step 307. Further, based on the details in the notification the PCF 109 updates SMF 107 at step 309 using Npcf_SMPolicyControl UpdateNotify Request for further processing. Accordingly, at step 311, the SMF 107 sends the Npcf_SMPolicyControl UpdateNotify Response to the PCF 109.

To gather from the process from FIGS. 2 and 3, a traffic influence request can occur in following ways:
AF can request traffic influence for a single ongoing PDU session, in which case the AF provides IPV4Addr or IPV6Addr or MACAddr in the request. In this case, the NEF translates the information and provides it to the PCF.
The AF can request traffic influence for a group of UEs or future PDU of a single or multiple UE or for ongoing PDUs without UE address, in which case the AF provides externalGroupId or externalGroupIds or anyUeInd or GPSI. In this case, the NEF stores the AF request in UDR under application-data/influence-data and the PCF will be notified provided that the PCF has subscribed with the UDR for application-data/influence-data.

The request includes traffic filters to identify single or multiple flows and routes to indicate single or list of DNAIs using attributes trafficFilters and trafficRoutes respectively. Table 1 depicts Table 5.4.3.3.2-1 and 5.4.3.3.3-1 of 3GPP TS 29.522, version 18.5.0. The TrafficFilters provide information about which data flow must be routed and TrafficRoutes provide information about where the data flow must be routed.

TABLE 1

| | | | | |
|---|---|---|---|---|
| trafficfilters | array(FlowInfo) | O | 1 . . . N | Identifies IP packet filters. |
| | | | | (NOTE\|3) |
| ethTrafficfilters | array(EthFlowDescription) | O | 1 . . . N | Identifies Ethernet packet |
| | | | | filters. |
| | | | | (NOTE\|3) |
| trafficRoutes | array(RouteToLocation) | O | 1 . . . N | Identifies the N6 traffic routing |
| | | | | requirement. (NOTE\|9) |

Thus, the conventional technique provides an AF that can provide a single set of traffic filters and the corresponding traffic routing requirements to request the NEF to trigger traffic influence for the traffic identified by the traffic filters based on the provided traffic routing requirements.

FIG. 4 illustrates a use case scenario 400 where the feeds from multiple security cameras are routed to a Data Network through the 5G Network. According to an example scenario 400, the external AF 101, processing the camera feeds at different DNAIs, can request the 5G Core 113 for dynamic routing of the same for specific purposes like video analytics and/or load sharing. Now, for the dynamic routing requirements, the AF 101 would interact with 5G Core 113 via NEF 103 by invoking Nnef_TrafficInfluence API. For the routing requirements, as illustrated in FIG. 4, the AF 101 requests multiple traffic filters to identify each stream and routing information for routing each stream to different DNAIs. However, according to the existing solutions, the NEF's interpretation of the AF request may not be in line with the AF's requirement. The problem can be explained through FIG. 5.

FIG. 5 illustrates an example scenario of the possible interpretation of attributes in the AF request, according to the state-of-the-art solution. Consider that AF wants to route, the dataflow at trafficFilter1 and trafficFilter2 to DNAI1 where the address details of the DNAI1 are included in the trafficRoute1 as shown in block 501. Similarly, the dataflow at trafficFilter3 is required to be routed to DNAI2 where the address details of DNAI2 are included in the trafficRoute2 as shown in block 501. Further, as per the conventional solution attributes trafficFilters and trafficRoutes are of data type array and do not carry any mapping between them. Further, in the AF request, the trafficFilters1 and the trafficFilters2 are packed into a single array of trafficFilters, and the DNAI1 and DNAI2 are packed into another single array of trafficRoutes. Accordingly, when the NEF receives the AF request, the two arrays look like two independent information as shown in block 503. Accordingly, as shown in block 505, the NEF may interpret to route the trafficFilter1, trafficFilter2, and trafficFilter3 to trafficRoute1 (i.e. at DNAI1). Further, in another scenario as shown in block 507, the NEF may interpret to route the trafficFilter1, trafficFilter2, and trafficFilter3 to trafficRoute2 (i.e. at DNAI2). Thus, the NEF of the 5G core fails to interpret the request sent by the uAF as intended by it.

Further, the problem can be overcome with multiple requests from the AF, each carrying a single routing requirement. However, such a solution is not an optimized approach as it adds up multiple API invocations and subscriptions in all 5G Core NFs involved-NEF, PCF, UDR, SMF.

Thus, there is a need to define a new methodology for optimizing the AF request to the core network for influencing multiple traffic flows in the communication network.

An objective of the present disclosure is to provide new attributes in a traffic influence request that includes a map comprising a plurality of sets where a set, in the plurality of sets, comprises a set identification number (SID), at least one traffic route, and one of at least one traffic filter or at least one ethernet traffic filter as attributes. The present disclosure defines the map as ““trafficDataSet”.

Another object of the present disclosure is to provide new attributes in a traffic influence update request that includes a map comprising at least a set, where a set, comprises a set identification number (SID) and other optional parameters. The optional parameters can be at least one traffic route, or one of at least one traffic filter or at least one ethernet traffic filter as attributes. The present disclosure defines the update map as “trafficDataSetRm”.

### BRIEF SUMMARY

The summary is provided to introduce aspects related to a method of communication in a cellular network, and the aspects are further described below in the detailed description. This summary is not intended to identify essential features of the claimed subject matter nor is it intended for use in determining or limiting the scope of the claimed subject matter.

According to an embodiment, the disclosure provides a methodology to create or update multiple requests for Traffic Influence service offered by NEF. The disclosed methodology generates a map having a mapping of at least one traffic filter or at least one ethernet traffic filter with at least one traffic route as new attributes. The map includes a set where each set comprises a set identification number (SID), one of: the at least one traffic filter or the at least one ethernet traffic filter, and the at least one traffic route as the attributes. According to an embodiment, the map defined as “trafficDataSet” is included in a request. Further, the request is sent to the NEF by the uAF. This assists the NEF in unambiguous interpretation of the uAF's create request. The SID acts as an identifier and is used as a key for each entry in the map. According to an embodiment, within each entry of the new attribute, the traffic filter information maps to the traffic route information. Similarly, there can be multiple entries of information in the map that has its own traffic filter information and traffic route information. This provides clarity for NEF to unambiguously interpret the external uAF's create requests and translate the information towards the other 5G Core entities.

According to a further embodiment, the disclosure provides a methodology to update the traffic request using an update map. The map includes a set identification number (SID) and other optional parameters. The optional parameters can be at least one traffic route, or one of at least one traffic filter or at least one ethernet traffic filter as attributes According to an embodiment, the map is included in a request and defined as “trafficDataSetRm”. Further, the request is sent to the NEF by the uAF. This assists the NEF in unambiguous interpretation of the uAF's update request.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates a general architecture of a 5G network. In general, the 5G network 100 includes an application function (AF) 101 that interacts with the NEF 103 for exposing the core network to an external AF 101 that is untrusted.

FIG. 2A illustrates a general Traffic Influence Service API method.

FIG. 2B illustrates a Traffic Influence Service call flow 200 between AF, NEF, PCF, and SMF.

FIG. 3 illustrates a Traffic Influence service call flow 300 between AF, NEF, PCF, UDR, and SMF.

FIG. 4 illustrates a use case scenario 400 where the feeds from multiple security cameras are routed to a Data Network through the 5G Network.

FIG. 5 illustrates an example scenario of the possible interpretation of attributes in the AF request, according to the state-of-the-art solution.

FIG. 6 illustrates an example scenario of the information received by NEF 103 or UDR 111 via a map, according to an embodiment of the present disclosure.

FIG. 7A illustrates a method for multiple traffic influencing by the AF, according to an embodiment of the present disclosure.

FIGS. 7B and 7C illustrate a signal flow between various network functions of the core network for influencing multiple traffic flows, according to an embodiment of the present disclosure.

FIG. 8 illustrates a method for multiple traffic influencing by NEF, according to an embodiment of the present disclosure. According to an embodiment, method 800 is implemented at NEF 103.

FIG. 9 illustrates a method for creating multiple traffic influencing requests traffic flows by the UDR, according to an embodiment of the present disclosure.

FIG. 9A illustrates a method 900A for multiple traffic influencing by the PCF, according to an embodiment of the present disclosure.

FIG. 10 illustrates a method for updating multiple traffic influencing requests by the uAF in a communication network, according to an embodiment of the present disclosure.

FIG. 11 illustrates a method for updating multiple traffic influencing requests by the NEF, according to an embodiment of the present disclosure.

FIG. 12 illustrates a method for updating multiple traffic influence by the UDR in the communication network, according to an embodiment of the present disclosure.

FIG. 13 illustrates a method for updating the multiple traffic influencing in the communication network, according to an embodiment of the present disclosure.

### DETAILED DESCRIPTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

The present disclosure provides a method for influencing multiple traffic flows in a communication network. In particular, the methods provide new attributes in a request that includes a map having a plurality of sets where each set includes a set identification number (SID), one of: the at least one traffic filter or the at least one ethernet traffic filter, and the at least one traffic route as the attributes. Further, each SID identifies each entry of at least one set in the map.

According to an embodiment, a new attribute with datatype as a map is included in a request sent by the AF. The request may be alternatively referred to as AF request or traffic influence request throughout the disclosure without deviating from the scope of the invention. According to an embodiment, the attributes include traffic filters or ethernet traffic filters and traffic routes in a map. The traffic filters or ethernet traffic filters are mapped with the traffic routes. According to a further embodiment, the map includes one or more sets. According to a further embodiment, each set comprises a set identification number (SID), one of: the at least one traffic filter or the at least one ethernet traffic filter, and the at least one traffic route as the attributes. More particularly, if the dataflow is related to ethernet then each set includes SID, the at least one ethernet traffic filter, and the at least one traffic route as the attributes. Otherwise, each set includes SID, the at least one traffic filter, and the at least one traffic route as the attributes.

According to an embodiment, multiple entries are present in the new attribute which holds sets of traffic filters or ethernet traffic filters and traffic routes. Table 2 illustrates new attributes that added in tables 5.4.3.3.2-1 and 5.4.3.3.3-1 of 3GPP TS 29.522, version 18.5.0. Table 3 illustrates the attributes that includes SID, traffic filters, ethernet traffic filters, and traffic routes.

TABLE 2

| | | | | | |
|---|---|---|---|---|---|
| trafficDataSets | map(TrafficDataSet) | O | 2 . . . N | Contains multiple sets of traffic | MultiTrafficInflu |
| | | | | filters with the corresponding | |
| | | | | N6 traffic routing requirements. | |
| | | | | The key of the map shall be the | |
| | | | | value of the “setId” attribute of | |
| | | | | the TrafficDataSet data type. | |

TABLE 3

| | | | | | |
|---|---|---|---|---|---|
| Attribute name | Data type | P | Cardinality | Description | Applicability |

| | | | | |
|---|---|---|---|---|
| setId | string | M | 1 | Identifies the traffic data set. |
| trafficFilters | array(FlowInfo) | C | 1 . . . N | Contains IP packet filters. |
| | | | | (NOTE) |
| ethTrafficFilters | array(EthFlowDescription) | C | 1 . . . N | Contains Ethernet packet |
| | | | | filters. |
| | | | | (NOTE) |
| trafficRoutes | array(RouteToLocation) | M | 1 . . . N | Contains the N6 traffic |
| | | | | routing requirements. |

(NOTE):
These attributes are mutually exclusive. Either one of them shall be present.

Accordingly, the addition of new attributes provides a way for the AF to indicate more than one set of traffic filters and the corresponding traffic routing requirements as a signaling optimization. This would otherwise require the AF to send multiple requests and manage as many resources. The NEF interprets the request, translates it and sends it to PCF or UDR.

According to a further embodiment, when the AF requests for a group of UE(s) or Any UE or an individual UE identified by GPSI or for future PDU session(s) or ongoing PDU sessions and the request does not have UE address, the NEF stores the map in the traffic influence data of application database of the UDR. According to an embodiment, the UDR provides the information to other network functions which have subscribed for the updates to this data. According, to an embodiment, the NEF interprets the information received from AF and sends it to UDR. If PCF has subscribed for the notification then UDR sends notification to it and PCF unambiguously interprets UDR's notification.

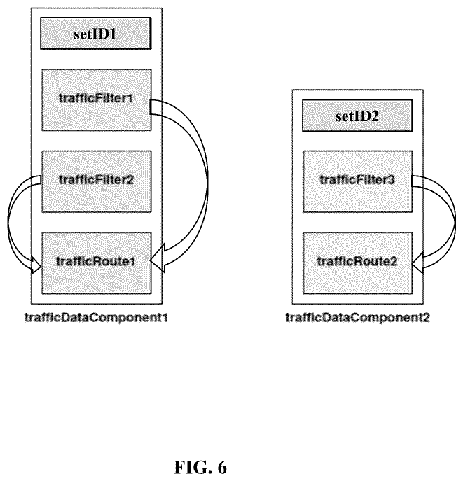

FIG. 6 illustrates an example scenario of the information received by NEF 103 or UDR 111 via a map, according to an embodiment of the present disclosure. The labels in the drawings are kept the same as applicable throughout the disclosure for ease of understanding.

According to an example scenario, the map includes two sets represented as the ‘trafficDataComponent1’ and ‘trafficDataComponent2’. The trafficDataComponent1 includes setId1 as SID, trafficFilter1 (let's say dataflow for stream1) and trafficFilter2 (let's say dataflow for stream2), and the trafficRoute1 (let's say application server address of DNAI1). Similarly, traffic DataComponent2 includes setId2 as SID, trafficFilter3 (let's say dataflow for stream3), and the trafficRoute2 (let's say application server address of DNAI2).

The NEF 103 receives this map in a single request and interprets the map as the trafficFilter1 and the trafficFilter2 that are to be routed at trafficRoute1 for set 1 (i.e. setID1) and trafficFilter3 to be routed at trafficRoute2 for set 2 (setID2). Further, the NEF 103 determines influencing the multiple traffic flows for a single ongoing protocol data unit (PDU) session with the corresponding UE address or future/ongoing PDU session(s) without the corresponding UE address from the received request. Accordingly, the NEF 103 translates the same to the PCF 109 for further processing if the NEF 103 determines influencing the multiple traffic flows for the ongoing PDU identified by the UE address provided in the request. Otherwise, the NEF 103 sends the map to the UDR 111 for storing in the database. The implementation details will be explained in the forthcoming paragraphs.

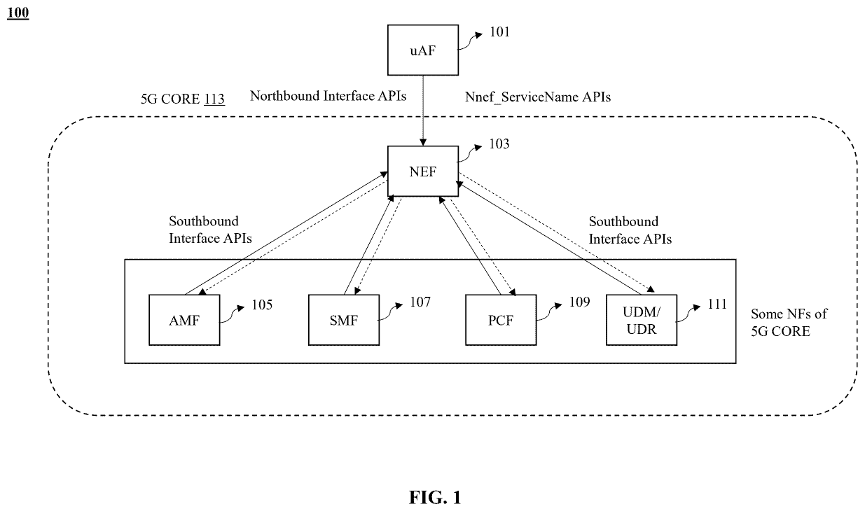

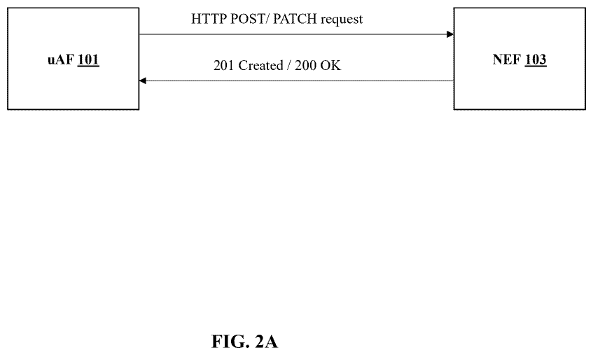

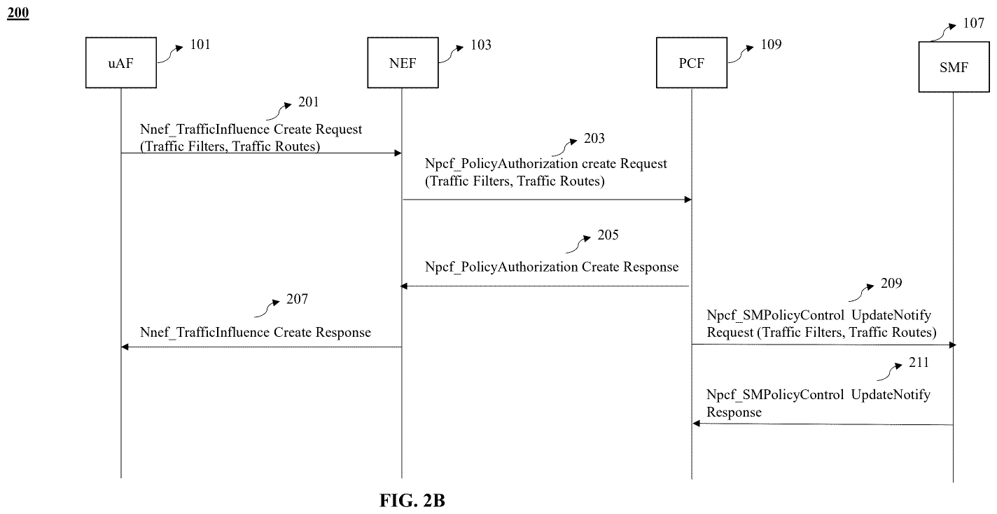

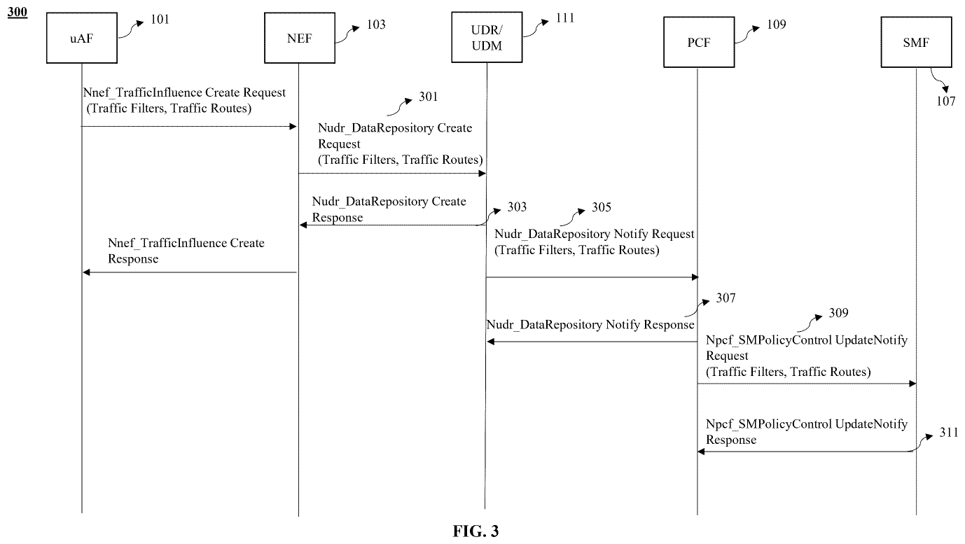

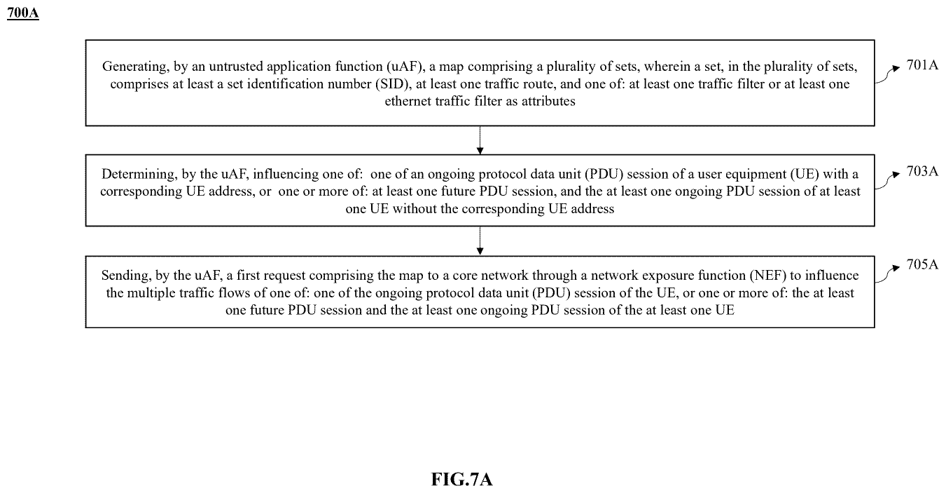

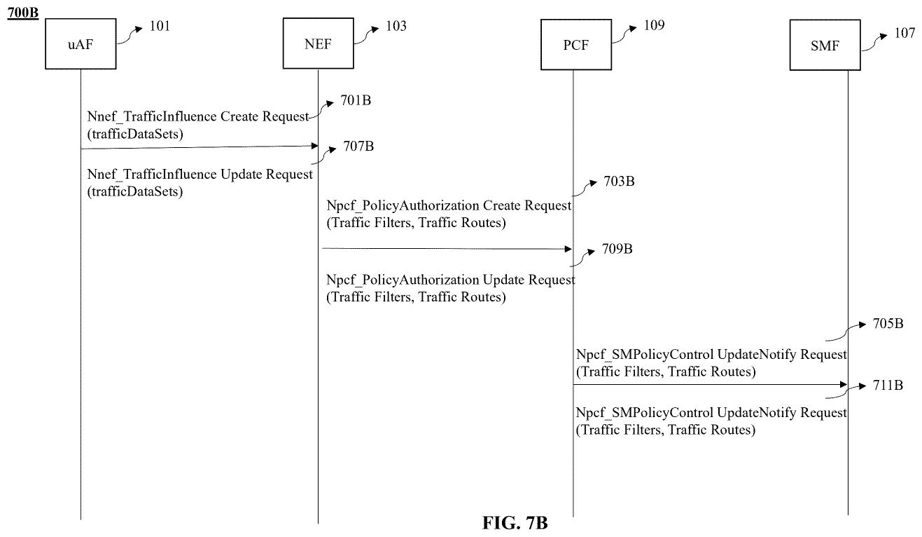

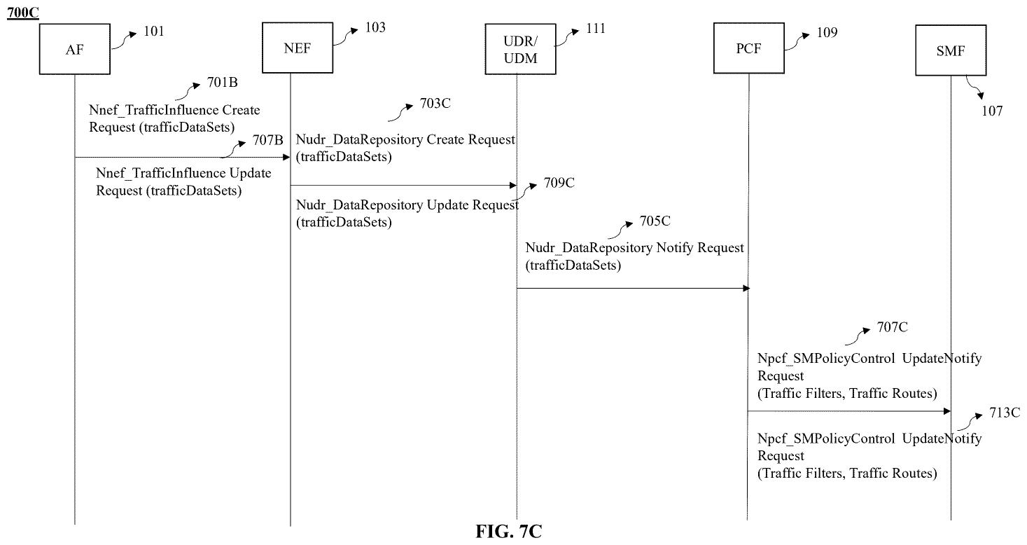

FIG. 7A illustrates a method 700A for multiple traffic influencing by the AF 101, according to an embodiment of the present disclosure. According to an embodiment, method 700 is implemented at AF 101. In an embodiment, the AF 101 is an external network function to the 5G core. In general, the AF 101 is the untrusted external network function, therefore the AF is alternatively referred to as untrusted AF (uAF) throughout the disclosure. According to some embodiment, the method 700A is implemented in the system 100 of FIG. 1.

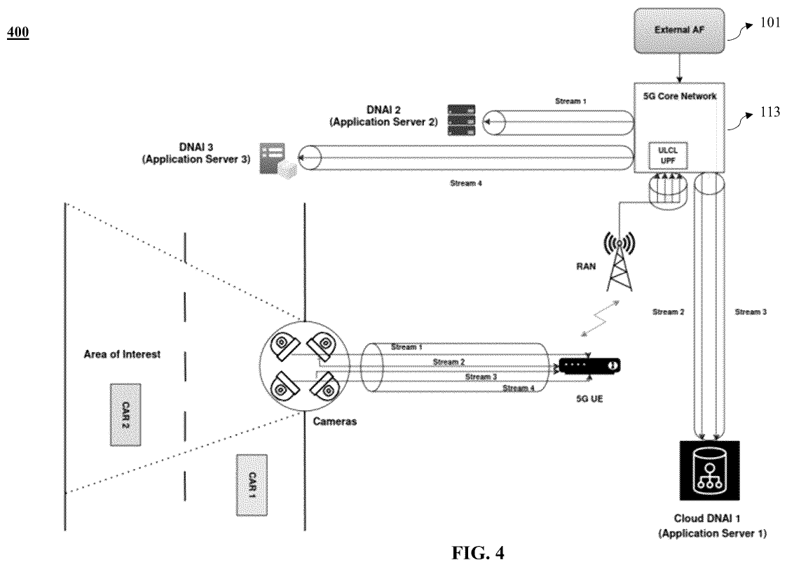

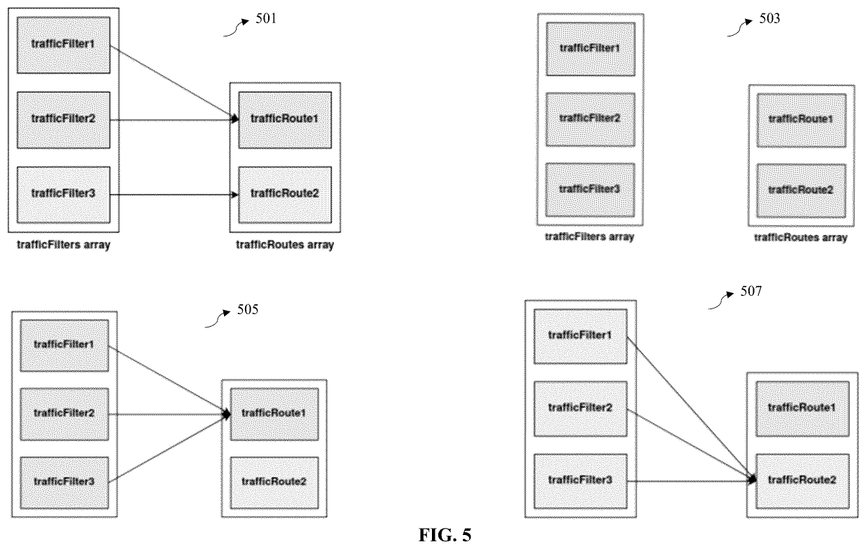

In an embodiment, whenever there is a requirement to create multiple requests to influence the traffic flow of feeds or streams as explained in the example scenario in FIG. 4, the uAF 101, at step 701A, generates a map having a plurality of sets using an attribute “trafficDataSets” associated with one of: at least one traffic filter or at least one ethernet traffic filter with at least one traffic route. The map comprises plurality of sets, each having a data type “trafficDataSet”. The attribute “trafficDataSets” is described in Table 2 and Table 3 above.

According to an embodiment, the set is of data type “trafficDataSet”. Further, the set comprises at least a set identification number (SID) (i.e. setID), one of: the at least one traffic filter (trafficFilters) or the at least one ethernet traffic filter (ethTrafficFilters), and the at least one traffic route (trafficRoutes) as the attributes, as depicted in Table 3.

According to an embodiment, the SID identifies each entry of at least one set in the map. In particular, the map includes one set for each request and includes the details of the set as each entry in the map. For example, as shown in FIG. 6, the map includes two sets having trafficDatacomponent1 and trafficDatacomponent2 where each entry is identified with SID. In an embodiment, the attribute associated with the SID is represented as ‘setId’ in a payload, and a datatype of the ‘setId’ is a string. Further, the traffic filters and the ethernet traffic filters are included in the map to identify data flow of one of the ongoing PDU session or the at least one future/ongoing PDU session(s). In an embodiment, the ongoing PDU session is associated with the at least one UE. Further, the future PDU session is associated with at least one of a group of UE(s), the UEs has set up a PDU session for a combination of Data Network Name (DNN) and Single Network Slice Assistance Information) S-NSSAI, and at least one of a group of UE(s) identified by one of the at least General Public Subscription Identifier (GPSI), Subscriber Permanent Identifier (SUPI) and External Group Identifier.

In an embodiment, the attributes associated with the one of: at least one traffic filter and the at least one ethernet filter are represented as ‘trafficFilters’ and ‘ethTrafficFilters’ respectively in the payload. The datatype of the ‘trafficFilters’ and ‘eth TrafficFilters’ are an array.

In an embodiment, the traffic route provides at least one application server address to which the data flow identified by the traffic filters or the ethernet traffic filters in the set is to be routed. The application servers may include DNAIs. The attribute associated with the traffic routes is represented as ‘trafficRoutes’ in the payload. The datatype of the ‘trafficRoutes’ is the array. The various attributes are depicted in the Tables 2 and 3.

According to an embodiment, at step 703A, the uAF 101 determines influencing the multiple traffic flows for one of an ongoing protocol data unit (PDU) session of a single user equipment (UE) with a corresponding UE address, or one or more of: at least one future PDU session, and the at least one ongoing PDU session of at least one UE without the corresponding UE address. Accordingly, the uAF 101 may determine influencing ongoing protocol data unit (PDU) session of a single user equipment (UE) having a corresponding UE address. Further, the uAF 101 may determine influencing at least one future PDU session, or the at least one ongoing PDU session of at least one UE without the corresponding UE address or a combination of both.

Further, at step 705A, the uAF 101 sends the request comprising the map to a core network through a Network Exposure Function (NEF) to influence the multiple traffic flows of one of: one of the ongoing protocol data unit (PDU) session of the UE, or one or more of: the at least one future PDU session and the at least one ongoing PDU session of the at least one UE. In particular, the uAF creates a ‘Nnef_TrafficInfluence Create’ request that includes the map having multiple sets.

FIGS. 7B and 7C illustrate a signal flow between various network functions of the core network for influencing multiple traffic flows, according to an embodiment of the present disclosure. In particular, FIG. 7B illustrates the signal flow between uAF, NEF, PCF, and SMF. Further, FIG. 7C illustrates the signal flow between uAF, NEF, UDR, PCF, and SMF. The signal flow as shown in FIGS. 7B and 7C will be explained through the functions at various network functions. Further, the labels for each step are kept the same for ease of understanding.

According to an embodiment, as the uAF 101 generates the map, the uAF sends the ‘Nnef_TrafficInfluence Create’ request, at step 701B, that includes the map having multiple sets. Thus, the ‘Nnef_TrafficInfluence Create’ request includes SIDs, traffic filters, traffic routes for each feed that is to be routed at target application servers or stored at the database. According to an embodiment, the map is included in a payload of ‘Nnef_TrafficInfluence Create’ request and sent to the NEF 103. Table 4 illustrates an example scenario of FIG. 6 showing how multiple traffic influence request fits into the payload of the AF request when the uAF 101 requests NEF 103.

TABLE 4

```
{
  “trafficDataSets”: {
  “1”: {
  1,
  trafficFilter1 & trafficFilter2,
  trafficRoute1
  },
  “2”: {
  2,
  trafficFilter3,
  trafficRoute2
  }
}
```

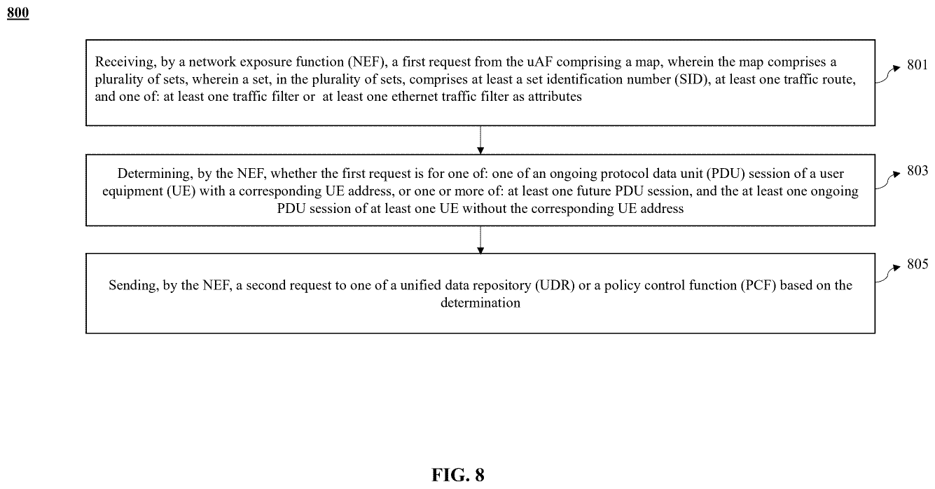

FIG. 8 illustrates a method for multiple traffic influencing by NEF, according to an embodiment of the present disclosure. According to an embodiment, method 800 is implemented at NEF 103. According to some embodiment, the method 800 is implemented in the system 100 of FIG. 1.

According to an embodiment, at step 801, the NEF 103, receives a request from the uAF 101 having the map. The map comprising a plurality of sets. Further, each set comprises at least SID, at least one traffic route, and one of: at least one traffic filter or at least one ethernet traffic filter as attributes. In an embodiment, the set has mapping of at least one traffic filter or at least one ethernet traffic filter with at least one traffic route as attributes. According to an embodiment, the NEF 103 receives the ‘Nnef_TrafficInfluence Create’ request from the uAF 101. Accordingly, the NEF 103 receives the map that includes SIDs, traffic filters, and traffic routes for each feed that is to be routed at target application servers. Thus, each set comprises the SID, one of: at least one traffic filter or at least one ethernet traffic filter, and at least one traffic route as the attributes which is sent by the uAF.

According to an embodiment, further, at step 803, the NEF 103 determines whether the request that is received from the uAF 101 is for one of: one of the ongoing PDU session of the single UE with a corresponding UE address, or one or more of: at least one future PDU session, and the at least one ongoing PDU session of at least one UE without the corresponding UE address. In an embodiment, the uAF 101 further sends other attributes in the ‘Nnef_TrafficInfluence Create’ request as per 3GPP specification. Accordingly, if the other attributes in the ‘Nnef_TrafficInfluence Create’ request include the corresponding UE address for one of the ongoing PDU session of one UE, then the NEF 103 determines that the request is for the ongoing PDU session. Further, if the other attributes in the ‘Nnef_TrafficInfluence Create’ request is without the UE address, then the NEF 103 determines that the request is for the future PDU session, or for at least one ongoing PDU session of at least one UE or for both.

According to an embodiment, the NEF 103 analyzes each entry in the map to interpret the map. In particular, the NEF 103 analyzes the mapping of the at least one traffic filter or at least one ethernet traffic filter with the at least one traffic route. Further, the NEF 103 translates the details provided in the map which is further utilized by the PCF 109 or UDR 111.

According to an embodiment, at step 805, the NEF 103 sends another request to one of a unified data repository (UDR) or a policy control function (PCF) based on the determination. In an embodiment, the second request comprises one of: the map or an interpretation of the map by the NEF 103. In an embodiment, the NEF 103 sends a ‘Npcf_PolicyAuthorization Create Request’ or a ‘Nudr_DataRepository Create Request’ to PCF or UDR respectively.

In an embodiment, the NEF 103 sends the Npcf_PolicyAuthorization Create Request at step 703B of FIG. 7B to the PCF 109 based on the determination that the request that is received from the uAF 101 is for one of the ongoing PDU sessions of the UE with the corresponding UE address. In this case, the another request corresponds to ‘Npcf_Policy Authorization Create’ as shown in step 703B of FIG. 7B. Accordingly, the NEF 103 sends the interpretation of the map in the ‘Npcf_Policy Authorization Create’ to the PCF 109. Thus, the map assists clarity for the NEF 103 to unambiguously interpret the external AF's request and translate the information toward the other 5G Core entities. Table 5 illustrates an example scenario of FIG. 6 showing how multiple traffic influence request from NEF is translated to the PCF.

TABLE 5

```
{
  “ascReqData”: {
  “medComponents”: {
  “1”: {
  1,
  “afRoutReq”: {
  trafficRoute1
  },
  “medSubComps”: {
  “1”: {
  1,
  trafficFilter1
  },
  “2”: {
  2,
  trafficFilter2
  }
  }
  }
  “2”: {
  2,
  “afRoutReq”: {
  trafficRoute3
  },
  “medSubComps”: {
  “1”: {
  1,
  trafficFilter3
  }
  }
  }
  }
}
```

In an embodiment, the PCF 109 analyses the request (Npcf_PolicyAuthorization Create) provided by the NEF 103 and provides information associated, at step 705B of FIG. 7B, with the attributes in the request to Session management function (SMF) 107 of the core network for implementing multiple traffic influencing in the ongoing PDU session's traffic flows. In an embodiment, the PCF 109 sends the Npcf_SMPolicyControl UpdateNotify Request at step 705B.

According to an embodiment, the NEF 103 sends the another request UDR 111 based on the determination that the request received from the uAF 101 is for one or more of: the at least one future PDU session and at least one ongoing PDU session of the at least one UE without corresponding UE address or for both. According to an embodiment, the another request includes the map for storing the attributes in a database of the UDR 111. In this case, the another request corresponds to ‘Nudr_DataRepository Create’ as depicted in step 703C of FIG. 7C.

According to an embodiment, the map is represented using an attribute “trafficDataSets” in a payload of the request received from the uAF. The set in the plurality of sets is of datatype “trafficDataSet”. Further, the SID identifies the set in the plurality of sets, wherein the SID is represented using the attribute “setId” in a payload of the request received from the uAF, where the attribute “setId” is of datatype string. Further, the at least one traffic filter is represented using the attribute “trafficFilters” and the at least one ethernet traffic filter is represented using the attribute “ethTrafficFilters” in the payload of the request received from the uAF 101. The attributes “trafficFilters” and “ethTrafficFilters” are of datatype array. In an embodiment, the at least one traffic route is represented using the attribute “trafficRoutes” in the payload of the request received from the uAF 101 having a datatype ‘array’.

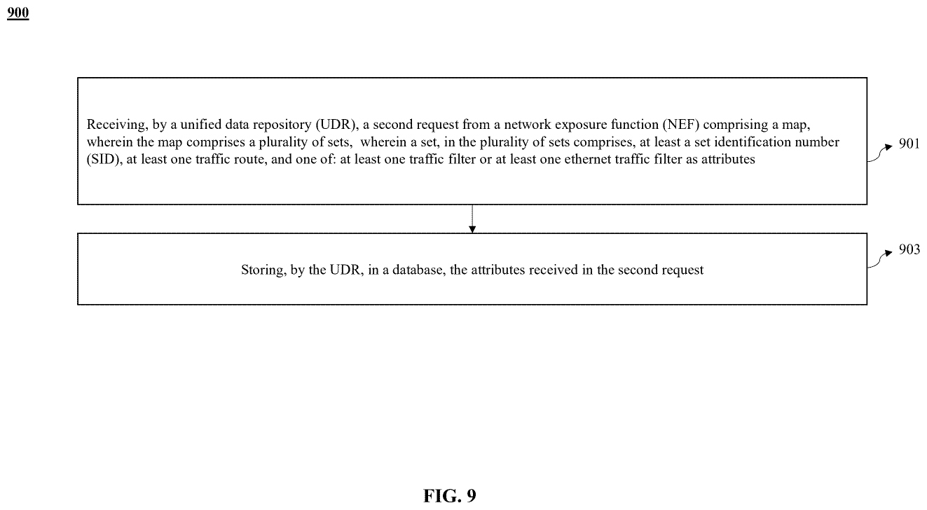

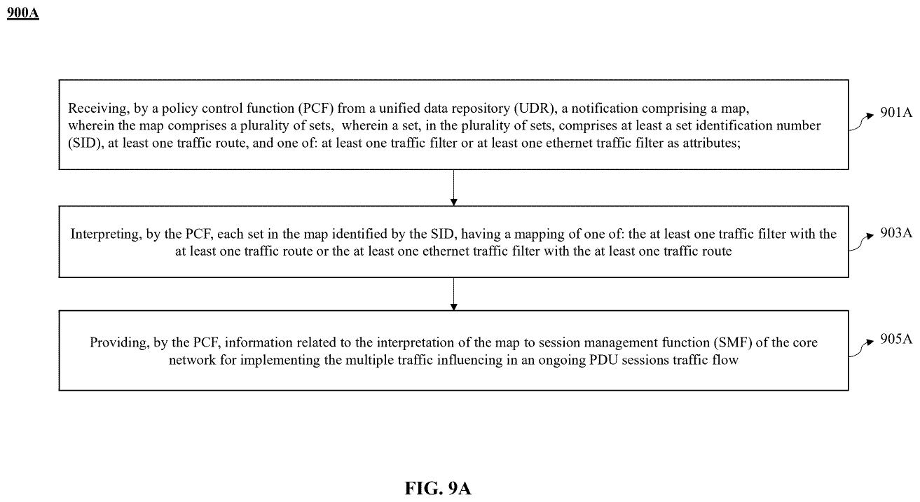

FIG. 9 illustrates a method for creating multiple traffic influencing requests for future PDUs' traffic flows or ongoing PDU session(s) or both without corresponding UE address by the UDR, according to an embodiment of the present disclosure. As explained above, when the request is determined for the future PDU session(s) or ongoing PDU session(s) or both without corresponding UE address, the NEF 103 sends the map to the UDR 111 for storing it in the database. Thus, if a network function subscribes with UDR 111 earlier or anytime later for application-data influence-data details in the map are sent to the respective network functions. The method 900 implemented in the UDR 111 is explained below.

According to an embodiment, at step 901, the UDR 111 receives a request i.e. Nudr_DataRepository Create Request (as shown in the step 703C) from the network exposure function (NEF) 103 comprising the map. As explained above, the map comprises the plurality of sets, where the set, in the plurality of sets, comprises at least the set identification number (SID), at least one traffic route, and one of: at least one traffic filter or at least one ethernet traffic filter as the attributes. The request received from the NEF 103 is for one or more of: at least one future PDU session or at least one ongoing PDU session without the corresponding UE address or a combination of both. Further, the map is represented using the attribute “trafficDataSets” in a payload of the request received from the NEF 103.

In an embodiment, the attributes associated with at least one traffic filter and the at least one ethernet filter, and at least one traffic route are represented as ‘trafficFilters’, ‘ethTrafficFilters’ and ‘trafficRoutes’ respectively in the payload of the received request from the NEF 103. Further, the at least one traffic route is represented using an attribute “trafficRoutes” in the payload of the received request from the NEF 103. Further, the SID identifies the set in the plurality of sets, where the SID is represented using the attribute “setId” in the payload of the request received from the NEF 103.

Further, at step 903, the UDR 111 stores in the database, the attributes received in the request. Table 6 illustrates how multiple traffic influence request is stored by the NEF 103 in UDR 111 for the example scenario of FIG. 6.

TABLE 6

```
{
  “trafficDataSets”: {
  “1”: {
  1,
  trafficFilter1 & trafficFilter2,
  trafficRoute1
  },
  “2”: {
  2,
  trafficFilter3,
  trafficRoute2
  }
}
```

According to an embodiment, the UDR 111 provides a request i.e. ‘Nudr_DataRepository Notify’ request, as shown in step 709 of FIG. 7, comprising the map to Policy Control Function (PCF) 109, at step 705C, that has subscribed to get this information for influencing the multiple traffic flows of at least one PDU session not identified by the UE address.

FIG. 9A illustrates a method 900A for multiple traffic influencing by the PCF, according to an embodiment of the present disclosure. According to an embodiment, at step 901A, the PCF 109 receives from the unified data repository (UDR) 111, a notification comprising the map. The map comprises the plurality of sets. The set, in the plurality of sets, comprises at least the set identification number (SID), at least one traffic route, and one of: at least one traffic filter or at least one ethernet traffic filter as attributes.

According to an embodiment, the PCF 109 receives the request i.e. ‘Nudr_DataRepository Notify’ request comprising the map from the UDR at step 705C. Further, at step 903A, the PCF 109 interprets each set in the map identified by the SID, having the mapping of one of: the at least one traffic filter with the at least one traffic route or the at least one ethernet traffic filter with the at least one traffic route. In particular, the PCF 109 analyses each entry in the map to interpret the request i.e. ‘Nudr_DataRepository Notify’ request and translates the information of the map. According to an embodiment, at step 905A, the PCF 109 provides the information related to the interpretation of the map to session management function (SMF) 107 at step 707C for further processing.

According to an embodiment, the map is represented using the attribute “trafficDataSets” in the payload of the notification. Further, the SID is represented using the attribute “setId” in the payload of the notification. Further, one of the at least one traffic filter is represented using the attribute “trafficFilters” or the at least one ethernet traffic filter is represented using the attribute “ethTrafficFilters” in the payload of the notification. Furthermore, the at least one traffic route is represented using the attribute “trafficRoutes” in the payload of the notification.

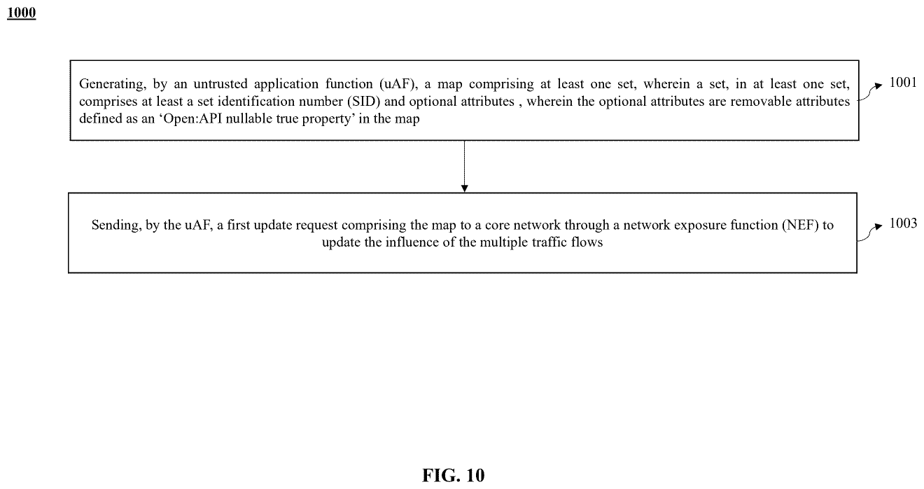

FIG. 10 illustrates a method for updating multiple traffic influencing by the uAF in a communication network, according to an embodiment of the present disclosure. According to some embodiment, in certain scenarios, when AF updates the multiple traffic influencing requests. Accordingly, the uAF 101 in such a scenario includes sets having a data type “trafficDataSetRm’. Further, the data type “trafficDataSetRm” has a OpenAPI “nullable: true” property which is as per the 3GPP specification.

According to an embodiment, at step 1001, the uAF 101 generates the map comprising at least one set. The set, in at least one set, comprises at least a set identification number (SID) and optional attributes. According to an embodiment, the optional attributes are optionally present in the map and are removable attributes that are defined as an ‘Open: API nullable true property’ in the map. Further, the optional attributes comprises one or more of: at least one traffic route and one of: at least one traffic filter or at least one ethernet traffic filter.

Further, at step 1003, the uAF 101 sends, an update request comprising the map to the core network 113 through the NEF 103 to update the influence of the multiple traffic flows. According to an embodiment, the uAF 101 sends the update request corresponding to Nnef_TrafficInfluence Update Request at step 707B of FIG. 7B.

In an embodiment, the map is represented using an attribute “trafficDataSets”. Further, the set in at least one set is of datatype “trafficDataSetRm” defined as the ‘Open: API nullable true property’ in the map. According to an embodiment, the SID identifies each entry of at least one set in the map, where the SID is represented using the attribute “setId” where the attribute “setId” is of datatype string.

According to an embodiment, attributes, and datatypes for the traffic filters, the ethernet traffic filters represented in the payload of the updated request remain the same as explained above. Therefore, for the sake of brevity, the same is not described here.
Table 7 illustrates new attributes i.e. “trafficDataSetRm”, that are added in the 3GPP specification. The detailed explanation of similar field is omitted for the sake of brevity. Further, Table 8 illustrates a definition of “trafficDataSetRm”.

TABLE 7

| Attribute name | Data type | P | Cardinality | Description | Applicability |
|---|---|---|---|---|---|
| trafficDataSets | map(TrafficDataSetRm) | O | 1 . . . N | Contains one or | MultiTrafficInflu |
| | | | | several set(s) of | |
| | | | | traffic filters with | |
| | | | | the corresponding | |
| | | | | N6 traffic routing | |
| | | | | requirements. | |
| | | | | The key of the | |
| | | | | map shall be the | |
| | | | | value of the | |
| | | | | “setId” attribute of | |
| | | | | the TrafficDataSet | |
| | | | | data type. | |

TABLE 8

| | | | | | |
|---|---|---|---|---|---|
| Attribute name | Data type | P | Cardinality | Description | Applicability |

| | | | | |
|---|---|---|---|---|
| setId | string | M | 1 | Identifies the |
| | | | | traffic data set. |
| trafficFilters | array(FlowInfo) | O | 1 . . . N | Contains IP |
| | | | | packet filters. |
| ethTrafficFilters | array(EthFlowDescription) | O | 1 . . . N | Contains |
| | | | | Ethernet packet |
| | | | | filters. |
| trafficRoutes | array(RouteToLocation) | O | 1 . . . N | Contains the N6 |
| | | | | traffic routing |
| | | | | requirements. |

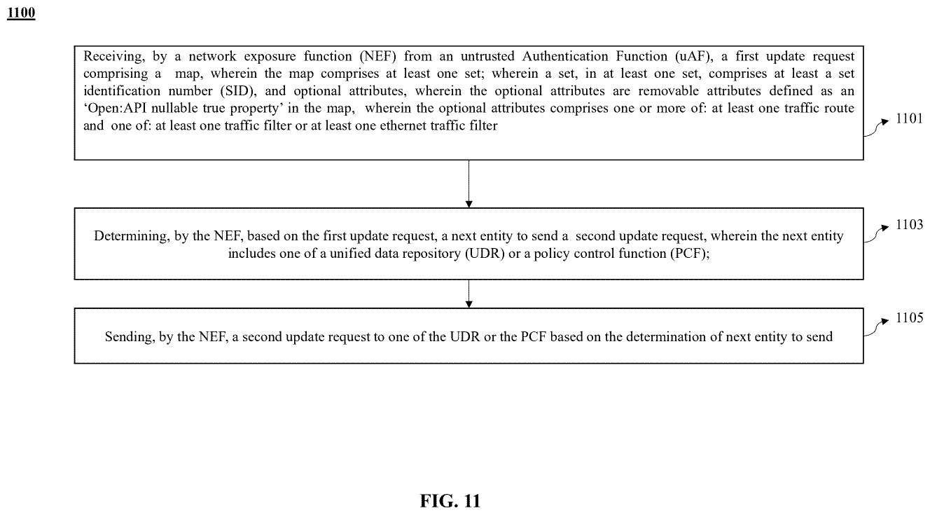

According to an embodiment, based on the determination of the previous request for traffic flow influence creation in UDR by NEF for storing the attributes in the database of the UDR, the NEF 103 sends third request i.e. ‘FIG. 11 illustrates a method 1100 for updating multiple traffic influencing requests by the NEF, according to an embodiment of the present disclosure.

According to an embodiment, at step 1101, the NEF 103 receives the first update request i.e. ‘Nnef_TrafficInfluence Update’ request along with the map from the uAF 101. The map comprises at least one set, where the set, in the at least one set, comprises at least the SID, and optional attributes. As explained above, the optional attributes are optionally present and are removable attributes that are defined as an ‘Open: API nullable true property’ in the map. The optional attributes comprises of one or more of: at least one traffic route or one of: at least one traffic filter or at least one ethernet traffic filter.

In an embodiment, the map is represented using the attribute “trafficDataSets” in a payload of the update request received from the uAF 101. Further, the set, in the at least one set, is of datatype “trafficDataSetRm” and defined as the ‘Open: API nullable true property’ in the map. Further, the SID identifies the set in the at least one set, wherein the SID is represented using the attribute “setId” in a payload of the update request, and wherein the attribute “setId” is of datatype string.

According to an embodiment, attributes, and datatypes for the traffic filters, the ethernet traffic filters represented in the payload of the updated request remain the same as explained in the above paragraphs. Therefore, for the sake of brevity, the same is not described here.

Further, at step 1103, based on the update request, the NEF 103 determines a next entity to send another update request based on action carried out during the corresponding create request. The next entity includes either the UDR 111 or the PCF 109. The action can be any traffic flow influence creation in the PCF 109 by the NEF 103 or traffic flow influence creation in the UDR 111 by the NEF 103 for storing the attributes in the database of the UDR 111. In an embodiment, another update request comprises either the map or an interpretation of the map.

Further, at step 1105, the NEF 103, sends another update request to either the UDR 111 or the PCF 109 based on the determination of the next entity to send. In an embodiment, the NEF 103 sends another update request to the UDR 111 based on the determination of the next entity being the UDR 111 based on the previous request for traffic influence creation in UDR 111. In particular, the NEF 103 determines about the next entity as the PCF 109 based on any previous request for traffic flow influence creation in the PCF 109, and sends another update request to the PCF 109.

In an embodiment, the NEF 103 sends the Npcf_PolicyAuthorization Update Request to PCF 109 when the NEF 103 determines that the next entity as PCF 109. According to an embodiment, the NEF 103 analyzes each entry in the map to interpret the map in the update request received from the uAF 101. Further, the NEF 103 forms the Npcf_PolicyAuthorization Update request having the interpretation of the map based on the analysis and sends the Npcf_PolicyAuthorization Update Request to PCF 109, at step 709B in FIG. 7B, comprising the interpretation of the map. The PCF 109 then sends the interpretation of the map to SMF 107 for further processing.

According to an embodiment, when the NEF 103 determines that the next entity as the UDR 111, the NEF 103 sends another update request corresponding to Nudr_DataRepository Update request, at step 709C in FIG. 7C, having the map, for storing the attributes in a database of the UDR 111.

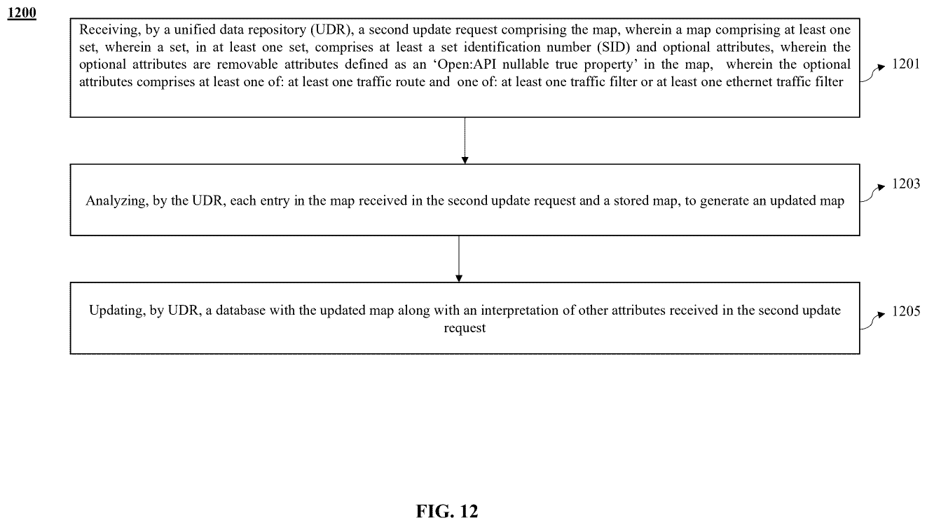

FIG. 12 illustrates a method 1200 for updating multiple traffic influence for future or ongoing PDUs' by the UDR in the communication network, according to an embodiment of the present disclosure.

According to an embodiment, at step 1201, the UDR 111 receives an update request i.e. ‘Nudr_DataRepository Update’ request along with the map. In an embodiment, the map comprises at least one set, where the set, in the at least one set, comprises at least the SID, and optional attributes. As explained above, the optional attributes are optionally present in the map and are removable attributes that are defined as an ‘Open: API nullable true property’ in the map. The optional attributes comprises one or more of: at least one traffic route or one of: at least one traffic filter or at least one ethernet traffic filter.

In an embodiment, the map is represented using the attribute “trafficDataSets” in a payload of the update request received from the uAF 101. Further, the set, in the at least one set, is of datatype “trafficDataSetRm” and defined as the ‘Open: API nullable true property’ in the map. Further, the SID identifies the set in the at least one set, wherein the SID is represented using the attribute “setId” in the payload of the update request, and wherein the attribute “setId” is of datatype string.

According to an embodiment, attributes, and datatypes for the traffic filters, the ethernet traffic filters represented in the payload of the updated request remain the same as explained in the above paragraphs. Therefore, for the sake of brevity, the same is not described here.

Further, at step 1203, the UDR 111 analyzes each entry in the map received in the update request and the stored map, to generate an updated map. Further, at step 1205, the UDR 111 updated the database with the updated map along with the interpretation of other attributes received in the update request.

According to an embodiment, the UDR 111 sends a notification comprising the updated map, to the PCF of the core network that has subscribed to the UDR 111 to receive the notification. In an embodiment, the UDR 111 sends a Nudr_DataRepository Notify Request at step 705C in FIG. 7C to the PCF 109 for further processing.

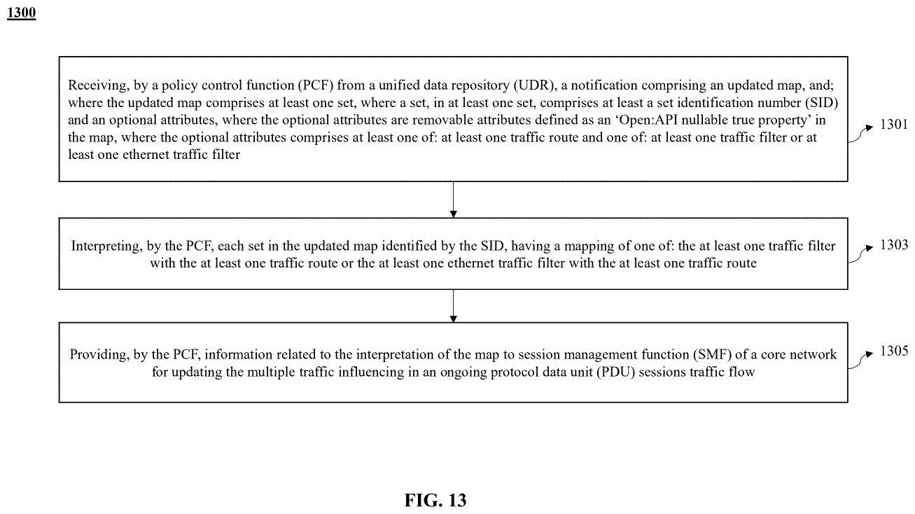

FIG. 13 illustrates a method 1300 for updating the multiple traffic influencing in the communication network, according to an embodiment of the present disclosure. According to an embodiment, at step 1301, the PCF 109 receives, from the UDR 111, the notification comprising the updated map through Nudr_DataRepository Notify Request.

The map comprises at least one set, where the at least one set, comprises at least the SID, and optional attributes. As explained above, the optional attributes are optionally present and are removable attributes that are defined as an ‘Open: API nullable true property’ in the map. The optional attributes comprise of one or more of: at least one traffic route or one of: at least one traffic filter or at least one ethernet traffic filter.

In an embodiment, the map is represented using the attribute “trafficDataSets” in a payload of the notification received from the UDR 111. Further, the set, in the at least one set, is of datatype “trafficDataSetRm” and defined as the ‘Open: API nullable true property’ in the map. Further, the SID identifies the set in the at least one set, wherein the SID is represented using the attribute “setId” in a payload, and wherein the attribute “setId” is of datatype string.

According to an embodiment, attributes, and datatypes for the traffic filters, the ethernet traffic filters represented in the payload remains the same as explained in the above paragraphs. Therefore, for the sake of brevity, the same is not described here.

Further, at step 1303, the PCF 109 interprets each set in the updated map identified by the SID, having a mapping of one of: the at least one traffic filter with the at least one traffic route or the at least one ethernet traffic filter with the at least one traffic route.

Further, at step 1305, the PCF 109 provides the information related to the interpretation of the map to the SMF 107 of the core network for updating the multiple traffic influencing in the ongoing PDU sessions traffic flow. In an embodiment, the PCF 109 provides the information related to the interpretation of the map through Npcf_SMPolicyControl UpdateNotify Request at step 713C in FIG. 7C.

According to the disclosed methodology, the addition of a new attribute in the NEF Traffic Influence service enables the NEF to unambiguously map and update the traffic filter information and traffic route information provided by the external AF. This in turn supports the other 5G Core entities to map the traffic filters(s) to the appropriate destination as per the intended request of uAF.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

1. A method of multiple traffic influencing in a communication network, the method comprising:
generating, by an untrusted application function (uAF), a map comprising a plurality of sets,
wherein a set, in the plurality of sets, comprises at least a set identification number (SID), at least one traffic route, and one of: at least one traffic filter or at least one ethernet traffic filter as attributes;
determining, by the uAF, influencing one of: one or more of: at least one future PDU session, and the at least one ongoing PDU session of at least one UE without the corresponding UE address, or one of an ongoing protocol data unit (PDU) session of a user equipment (UE) with a corresponding UE address; and
sending, by the uAF, a first request comprising the map to a core network through a network exposure function (NEF) to influence the multiple traffic flows of one of: one or more of: the at least one future PDU session and the at least one ongoing PDU session of the at least one UE or one of the ongoing protocol data unit (PDU) session of the UE.

2. The method as claimed in claim 1, wherein the map is represented using an attribute “trafficDataSets” in a payload of the first request.

3. The method as claimed in claim 1, wherein the set in the plurality of sets is of datatype “trafficDataSet”.

4. The method as claimed in claim 1, wherein the SID identifies the set in the plurality of sets, wherein the SID is represented using the attribute “setId” in a payload of the first request, and wherein the attribute “setId” is of datatype string.

5. The method as claimed in claim 1, wherein
one of: the at least one traffic filter or the at least one ethernet traffic filter identifies the traffic flow of one of: one or more of: the at least one future PDU session and the at least one ongoing PDU session of the at least one UE, or one of the ongoing PDU session of the UE,
one of: the at least one traffic filter is represented using the attribute “trafficFilters” or the at least one ethernet traffic filter is represented using the attribute “ethTrafficFilters” in a payload of the first request, and
the attributes “trafficFilters” and “ethTrafficFilters” are of datatype array.

6. The method as claimed in claim 1, wherein
the at least one traffic route identifies at least one application server address,
the at least one traffic route is represented using an attribute “trafficRoutes” in the request payload, and
the attribute “trafficRoutes” is of datatype array.

7. A method of multiple traffic influencing in a communication network comprising:
receiving, by a network exposure function (NEF), a first request from an untrusted application function (uAF) comprising a map,
wherein the map comprises a plurality of sets,
wherein a set, in the plurality of sets, comprises at least a set identification number (SID), at least one traffic route, and one of: at least one traffic filter or at least one ethernet traffic filter as attributes;
determining, by the NEF, whether the first request is for one of: one or more of: at least one future PDU session, and the at least one ongoing PDU session of at least one UE without the corresponding UE address, or one of an ongoing protocol data unit (PDU) session of a user equipment (UE) with a corresponding UE address; and
sending, by the NEF, a second request to one of a unified data repository (UDR) or a policy control function (PCF) based on the determination.

8. The method as claimed in claim 7, wherein the second request is sent to the UDR based on the determination that the first request is for one or more of: the at least one future PDU session and the at least one ongoing PDU session of the at least one UE without corresponding UE address.

9. The method as claimed in claim 7, wherein the second request is sent to the PCF based on the determination that the first request is for one of the ongoing PDU sessions of the UE with the corresponding UE address.

10. The method as claimed in claim 7, wherein the second request comprises one of: the map or an interpretation of the map by the NEF.

11. The method as claimed in claim 10, wherein the second request comprising the map is sent to the UDR.

12. The method as claimed in claim 10, wherein
analyzing, by the NEF, each entry in the map to interpret the map;
generating, by the NEF, the second request based on the analysis; and
sending, by the NEF, the second request to the PCF comprises the interpretation of the map.

13. The method as claimed in claim 7, wherein the map is represented using an attribute “trafficDataSets” in a payload of the first request.

14. The method as claimed in claim 7, wherein the set in the plurality of sets is of datatype “trafficDataSet”.

15. The method as claimed in claim 7, wherein the SID identifies the set in the plurality of sets, wherein the SID is represented using the attribute “setId” in a payload of the first request, and wherein the attribute “setId” is of datatype string.

16. The method as claimed in claim 7, wherein
one of: the at least one traffic filter or the at least one ethernet traffic filter identifies the traffic flow of one of: one or more of: the at least one future PDU session and the at least one ongoing PDU session of the at least one UE, or one of the ongoing PDU session of the UE,
one of: the at least one traffic filter is represented using the attribute “trafficFilters” or the at least one ethernet traffic filter is represented using the attribute “ethTrafficFilters” in a payload of the first request, and
the attributes “trafficFilters” and “ethTrafficFilters” are of datatype array.

17. The method as claimed in claim 7, wherein
the at least one traffic route identifies at least one application server address,
the at least one traffic route is represented using an attribute “trafficRoutes” in a payload of the first request, and
the attribute “trafficRoutes” is of datatype array.

18. A method for storing multiple traffic influencing requests in a communication network comprising:
receiving, by a unified data repository (UDR), a second request from a network exposure function (NEF) comprising a map,
wherein the map comprises a plurality of sets,
wherein a set, in the plurality of sets comprises at least a set identification number (SID), at least one traffic route, and one of: at least one traffic filter or at least one ethernet traffic filter as attributes; and
storing, by the UDR, in a database, the attributes received in the second request.

19. The method as claimed in claim 18, wherein the second request is for one or more of: at least one future PDU session and at least one ongoing PDU session without a corresponding UE address.

20. The method as claimed in claim 18, further comprising:
sending, by the UDR, a notification comprising the map, to a policy control function (PCF) of a core network that has subscribed to the UDR to receive the notification.

21. The method as claimed in claim 18, wherein the map is represented using the attribute “trafficDataSets” in a payload of the second request.

22. The method as claimed in claim 18, wherein the set in the plurality of sets is of datatype “trafficDataSet”.

23. The method as claimed in claim 18, wherein the SID identifies the set in the plurality of sets, wherein the SID is represented using the attribute “setId” in a payload of the second request, and the attribute “setId” is of datatype string.

24. The method as claimed in claim 18, wherein
one of: the at least one traffic filter or the at least one ethernet traffic filter identifies the traffic flow of one or more of: the at least one future PDU session and the at least one ongoing PDU session of the at least one UE,
one of: the at least one traffic filter is represented using the attribute “trafficFilters” or the at least one ethernet traffic filter is represented using the attribute “ethTrafficFilters” in a payload of the second request, and
the attributes “trafficFilters” and “ethTrafficFilters” are of datatype array.

25. The method as claimed in claim 18, wherein the at least one traffic route identifies at least one application server address,
the at least one traffic route is represented using an attribute “trafficRoutes” in a payload of the second request, and
the attribute “trafficRoutes” is of datatype array.

26. A method of multiple traffic influencing in a communication network comprising:
receiving, by a policy control function (PCF) from a unified data repository (UDR), a notification comprising a map,
wherein the map comprises a plurality of sets,
wherein a set, in the plurality of sets, comprises at least a set identification number (SID), at least one traffic route, and one of: at least one traffic filter or at least one ethernet traffic filter as attributes;
interpreting, by the PCF, each set in the map identified by the SID, having a mapping of one of: the at least one traffic filter with the at least one traffic route or the at least one ethernet traffic filter with the at least one traffic route; and
providing, by the PCF, information related to the interpretation of the map to session management function (SMF) of the core network for implementing the multiple traffic influencing in an ongoing PDU sessions traffic flow.

27. The method as claimed in claim 26, wherein the map is represented using the attribute “trafficDataSets” in a payload of the notification.

28. The method as claimed in claim 26, wherein the set in the plurality of sets is of datatype “trafficDataSet”.

29. The method as claimed in claim 26, wherein the SID identifies the set in the plurality of sets, wherein the SID is represented using the attribute “setId” in a payload of the notification, and wherein the attribute “setId” is of datatype string.

30. The method as claimed in claim 26, wherein
one of: the at least one traffic filter or the at least one ethernet traffic filter identifies the traffic flow of one or more of: the at least one future PDU session and the at least one ongoing PDU session of the at least one UE,
one of: the at least one traffic filter is represented using the attribute “trafficFilters” or the at least one ethernet traffic filter is represented using the attribute “ethTrafficFilters” in a payload of the notification, and
the attributes “trafficFilters” and “ethTrafficFilters” are of datatype array.

31. The method as claimed in claim 26, wherein
the at least one traffic route identifies at least one application server address,
the at least one traffic route is represented using an attribute “trafficRoutes” in a payload of the notification, and
the attribute “trafficRoutes” is of datatype array.

32. A method of multiple traffic influencing in a communication network, the method comprising:
generating, by an untrusted application function (uAF), a map comprising at least one set,
wherein a set, in at least one set, comprises at least a set identification number (SID) and optional attributes,
wherein the optional attributes are removable attributes defined as an ‘Open: API nullable true property’ in the map,
wherein the optional attributes comprises one or more of: at least one traffic route and one of: at least one traffic filter or at least one ethernet traffic filter; and
sending, by the uAF, a first update request comprising the map to a core network through a network exposure function (NEF) to update the influence of the multiple traffic flows.

33. The method as claimed in claim 32, wherein the map is represented using an attribute “trafficDataSets” in a payload of the first update request.

34. The method as claimed in claim 32, wherein the set in at least one set is of datatype “trafficDataSetRm” defined as the ‘Open: API nullable true property’ in the map.

35. The method as claimed in claim 32, wherein the SID identifies the set in the plurality of sets, wherein the SID is represented using the attribute “setId” in a payload of the first update request, and wherein the attribute “setId” is of datatype string.

36. The method as claimed in claim 32, wherein one of: the at least one traffic filter or the at least one ethernet traffic filter identifies a traffic flow of one of: one or more of: at least one future PDU session and at least one ongoing PDU session of at least one UE, or one of ongoing protocol data unit (PDU) session of a user equipment (UE),
one of: the at least one traffic filter is represented using the attribute “trafficFilters” or the at least one ethernet traffic filter is represented using the attribute “ethTrafficFilters” in a payload of the first update request, and
the attributes “trafficFilters” and “ethTrafficFilters” are of datatype array.

37. The method as claimed in claim 32, wherein
the at least one traffic route identifies at least one application server address,
the at least one traffic route is represented using an attribute “trafficRoutes” in a payload of the first request, and
the attribute “trafficRoutes” is of datatype array.

38. A method of multiple traffic influencing in a communication network comprising:
receiving, by a network exposure function (NEF) from an untrusted Authentication Function (uAF), a first update request comprising a map,
wherein the map comprises at least one set;
wherein a set, in at least one set, comprises at least a set identification number (SID), and optional attributes,
wherein the optional attributes are removable attributes defined as an ‘Open: API nullable true property’ in the map,
wherein the optional attributes comprises one or more of: of at least one traffic route and one of: at least one traffic filter or at least one ethernet traffic filter;
determining, by the NEF, based on the first update request, a next entity to send a second update request, wherein the next entity includes one of a unified data repository (UDR) or a policy control function (PCF); and
sending, by the NEF, a second update request to one of the UDR or the PCF based on the determination of next entity to send.

39. The method as claimed in claim 38, wherein the second update request comprises one of: the map or an interpretation of the map.

40. The method as claimed in claim 38, wherein the second update request, comprising the map, is sent to the UDR based on the determination of the next entity being the UDR.

41. The method as claimed in claim 38, further comprising:
analyzing, by the NEF, each entry in the map to interpret the map in the first update request;
forming the second update request having the interpretation of the map based on the analysis; and
sending, by the NEF, the second update request to the PCF comprising the interpretation of the map.

42. The method as claimed in claim 38, wherein the map is represented using an attribute “trafficDataSets” in a payload of the first update request.

43. The method as claimed in claim 38, wherein the set, in the at least one set, is of datatype “trafficDataSetRm” and defined as the ‘Open: API nullable true property’ in the map.

44. The method as claimed in claim 38, wherein the SID identifies the set in the at least one set, wherein the SID is represented using the attribute “setId” in a payload of the first request, and wherein the attribute “setId” is of datatype string.

45. The method as claimed in claim 38, wherein
one of: the at least one traffic filter or the at least one ethernet traffic filter identifies the traffic flow of one of: one or more of: the at least one future PDU session and the at least one ongoing PDU session of at least one UE, or one of ongoing protocol data unit (PDU) session of a user equipment (UE),
one of: the at least one traffic filter is represented using the attribute “trafficFilters” or the at least one ethernet traffic filter is represented using the attribute “ethTrafficFilters” in a payload of the first update request, and
the attributes “trafficFilters” and “ethTrafficFilters” are of datatype array.

46. The method as claimed in claim 38, wherein
the at least one traffic route identifies at least one application server address,
the at least one traffic route is represented using an attribute “trafficRoutes” in a payload of the first update request, and
the attribute “trafficRoutes” is of datatype array.

47. A method for storing multiple traffic influencing requests in a communication network comprising:
receiving, by a unified data repository (UDR), a second update request comprising the map,
wherein a map comprising at least one set,
wherein a set, in at least one set, comprises at least a set identification number (SID) and optional attributes,
wherein the optional attributes are removable attributes defined as an ‘Open: API nullable true property’ in the map,
wherein the optional attributes comprises one or more of: at least one traffic route and one of: at least one traffic filter or at least one ethernet traffic filter;
analyzing, by the UDR, each entry in the map received in the second update request and a stored map, to generate an updated map; and
updating, by UDR, a database with the updated map along with an interpretation of other attributes received in the second update request.

48. The method as claimed in claim 47, further comprising:
sending, by the UDR, a notification comprising the updated map, to the policy control function (PCF) of a core network that has subscribed to the UDR to receive the notification.

49. The method as claimed in claim 47, wherein the map is represented using an attribute “trafficDataSets” in a payload of the second update request.

50. The method as claimed in claim 47, wherein the set, in at least one set, is of datatype “trafficDataSetRm” and defined as the ‘Open: API nullable true property’ in the map.

51. The method as claimed in claim 47, wherein the SID identifies the set, in the at least one set, wherein the SID is represented using the attribute “setId” in a payload of the second update request, and wherein the attribute “setId” is of datatype string.

52. The method as claimed in claim 47, wherein
one of: the at least one traffic filter or the at least one ethernet traffic filter identifies the traffic flow of one or more of: the at least one future PDU session and the at least one ongoing PDU session of the at least one UE,
one of: the at least one traffic filter is represented using the attribute “trafficFilters” or the at least one ethernet traffic filter is represented using the attribute “ethTrafficFilters” in a payload of the second update request, and
the attributes “trafficFilters” and “ethTrafficFilters” are of datatype array.

53. The method as claimed in claim 47, wherein
the at least one traffic route identifies at least one application server address,
the at least one traffic route is represented using an attribute “trafficRoutes” in a payload of the second update request, and
the attribute “trafficRoutes” is of datatype array.

54. A method of multiple traffic influencing in a communication network comprising:
receiving, by a policy control function (PCF) from a unified data repository (UDR), a notification comprising an updated map, and;
wherein the updated map comprises at least one set,
wherein a set, in at least one set, comprises at least a set identification number (SID) and an optional attributes,
wherein the optional attributes are removable attributes defined as an ‘Open: API nullable true property’ in the map,
wherein the optional attributes comprises one or more of: at least one traffic route and one of: at least one traffic filter or at least one ethernet traffic filter;
interpreting, by the PCF, each set in the updated map identified by the SID, having a mapping of one of: the at least one traffic filter with the at least one traffic route or the at least one ethernet traffic filter with the at least one traffic route; and
providing, by the PCF, information related to the interpretation of the map to session management function (SMF) of a core network for updating the multiple traffic influencing in an ongoing protocol data unit (PDU) sessions traffic flow.

55. The method as claimed in claim 54, wherein the map is represented using an attribute “trafficDataSets” in a payload of the notification.

56. The method as claimed in claim 54, wherein the set, in at least one set, is of datatype “trafficDataSetRm” and defined as the ‘Open: API nullable true property’ in the map.

57. The method as claimed in claim 54, wherein the SID identifies the set, in the at least one set, wherein the SID is represented using the attribute “setId” in a payload of the notification, and wherein the attribute “setId” is of datatype string.

58. The method as claimed in claim 54, wherein
one of: the at least one traffic filter or the at least one ethernet traffic filter identifies the traffic flow of one or more of: the at least one future PDU session and the at least one ongoing PDU session of the at least one UE,
one of: the at least one traffic filter is represented using the attribute “trafficFilters” or the at least one ethernet traffic filter is represented using the attribute “ethTrafficFilters” in a payload of the second update request, and
the attributes “trafficFilters” and “ethTrafficFilters” are of datatype array.

59. The method as claimed in claim 54, wherein
the at least one traffic route identifies at least one application server address,
the at least one traffic route is represented using an attribute “trafficRoutes” in a payload of the second update request, and
the attribute “trafficRoutes” is of datatype array.
